(19) United States
(12) Patent Application Publication
(10) Pub. No.: US 2018/0025518 A1
(43) Pub. Date: Jan. 25, 2018

(54) UNMANNED AIR VEHICLE SYSTEM

(71) Applicant: Panasonic Intellectual Property Management Co., Ltd., Osaka (JP)

(72) Inventor: Satoshi HORIE, Hyogo (JP)

(21) Appl. No.: 15/425,373

(22) Filed: Feb. 6, 2017

(30) Foreign Application Priority Data
Jul. 22, 2016 (JP) 2016-144478

(51) Int. Cl. G06T 11/60; B64D 47/08; G05D 1/00; B64C 39/02; G06K 9/00; H04N 7/18

(52) U.S. Cl. CPC G06T 11/60; G06K 9/0063; H04N 7/181; G05D 1/0038; B64C 39/024; B64D 47/08; B64C 2201/146

(57) ABSTRACT

An unmanned air vehicle system includes an unmanned air vehicle including a camera unit, a pilot terminal capable of piloting the unmanned air vehicle, and a display that displays images captured by the camera unit. The camera unit includes a first camera that captures a first image and a second camera that captures a second image. An angle of view of the first camera is narrower than an angle of view of the second camera.

### BACKGROUND

### 1. Technical Field

The present disclosure relates to an unmanned air vehicle (UAV) system.

### 2. Description of the Related Art

Many of unmanned air vehicles are equipped with cameras. An image signal obtained from such a camera is used not only as a method of data acquisition but also for purposes of check of the image signal on the ground as needed and assistance in piloting the unmanned air vehicle. Unexamined Japanese Patent Publication No. 2016-94188 discloses controlling an unmanned air vehicle by using an image captured by a camera mounted on the unmanned air vehicle.

When an unmanned air vehicle body is at a distance where the unmanned air vehicle body can be visually perceived, it is possible to perform operations while looking at the actual unmanned air vehicle. However, when the unmanned air vehicle is at a distance too far to be visually perceived, or when the unmanned air vehicle is at a distance where checking a direction of the unmanned air vehicle is difficult although visual perception is possible, the aforementioned image signal is useful for controlling the unmanned air vehicle.

### SUMMARY

An unmanned air vehicle system according to the present disclosure includes an unmanned air vehicle including a camera unit, a pilot terminal capable of controlling the unmanned air vehicle, and a display that displays an image captured by the camera unit. The camera unit includes a first camera that captures a first image and a second camera that captures a second image. An angle of view of the first camera is narrower than an angle of view of the second camera.

### BRIEF DESCRIPTION OF THE DRAWINGS

FIG. 1 is a diagram illustrating an overall configuration of an unmanned air vehicle system according to the first exemplary embodiment;

FIG. 2 is a diagram illustrating an electric configuration of a camera unit according to the first exemplary embodiment;

FIG. 3 is a diagram illustrating an electric configuration of a pilot terminal according to the first exemplary embodiment;

FIG. 4 is a diagram illustrating a configuration of an unmanned air vehicle equipped with another camera unit according to the first exemplary embodiment;

FIG. 5 is an operating sequence diagram illustrating one example of an operation of the unmanned air vehicle system according to the first exemplary embodiment;

FIG. 6 is a diagram illustrating a display example of an image displayed on a display;

FIG. 7 is a diagram illustrating a display example of the image displayed on the display;

FIG. 8 is a diagram illustrating a display example of the image displayed on the display;

FIG. 9 is a diagram illustrating a display example of the image displayed on the display;

FIG. 10 is a diagram illustrating a display example of the image displayed on the display;

FIG. 11 is a diagram illustrating a display example of the image displayed on the display; and

FIG. 12 is a diagram illustrating a display example of the image displayed on the display.

### DETAILED DESCRIPTION

The exemplary embodiments will be described in detail below with reference to the drawings as needed. However, a description more detailed than necessary may be omitted. For example, a detailed description of an already well-known matter and a repeated description of substantially identical components ay be omitted. This is intended to avoid the following description from becoming unnecessarily redundant and to make the description easier for a person skilled in the art to understand.

It is to be noted that the applicant provides the accompanying drawings and the following description in order for a person skilled in the art to fully understand the present disclosure, and that the applicant does not intend to limit the subject described in the appended claims.

Examples of application of an unmanned air vehicle system of the present disclosure include crime prevention and security applications. For example, chasing a specified car or person with an unmanned air vehicle can be assumed.

Examples of unmanned air vehicle include a remotely pilotable helicopter and an unmanned rotorcraft such as a quadcopter. A pilot can pilot the unmanned air vehicle from a remote place using a pilot terminal.

The unmanned air vehicle includes a main camera as a first camera and a sub camera as a second camera. The main camera is equipped with a telephoto lens having an angle of view narrower than an angle of view of the sub camera. The sub camera is equipped with a wide-angle lens having an angle of view wider than an angle of view of the main camera.

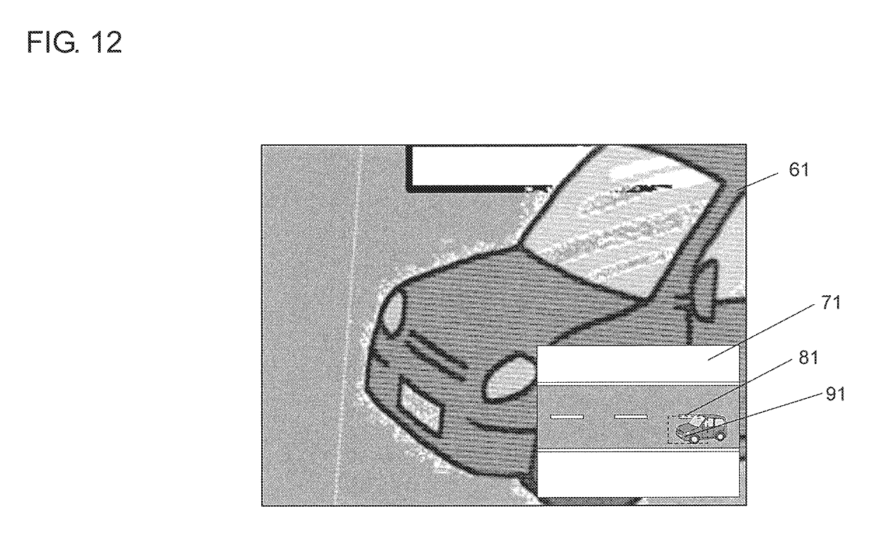

The main camera can capture a license plate of a car, a face of a person, and the like, whereas the sub camera can capture a surrounding scene including cars, persons, and the like. These images can be displayed on a display. FIG. 12 is one example of display of these images on the display. In FIG. 12, an image captured by the sub camera (second image 71) and an image captured by the main camera (first image 61) are displayed in a superimposed manner. Such images are used by an operator such as the pilot of the unmanned air vehicle and a photographer of a camera unit.

While checking a target car or person in detail from the image on the display, the pilot can obtain geographic information on extensive surroundings and information such as a position of the unmanned air vehicle itself and a direction in which the unmanned air vehicle is heading. Therefore, the pilot can pilot the unmanned air vehicle more accurately.

Also, when capturing an image with a camera, the pilot can capture a target image with the main camera while checking overall positional relationship and direction with the image with the sub camera. Therefore, for example, the pilot can also adjust a direction of the main camera while checking the image. That is, more accurate data can be collected.

When only one camera is used, a camera with a narrow angle of view does not provide sufficient geographic information on the surroundings, which makes it difficult to know a position of the unmanned air vehicle and the direction in which the unmanned air vehicle is heading. Also, a camera with a narrow angle of view may make it difficult to know the position and direction of a main target subject, and make it difficult to perform accurate capturing. Meanwhile, the present disclosure, which uses a camera of a wide angle of view and a camera of a narrow angle of view, is advantageous in terms of both piloting and data collection.

The display displays images by various methods. Exemplary embodiments will be described below including image display examples.

### First Exemplary Embodiment

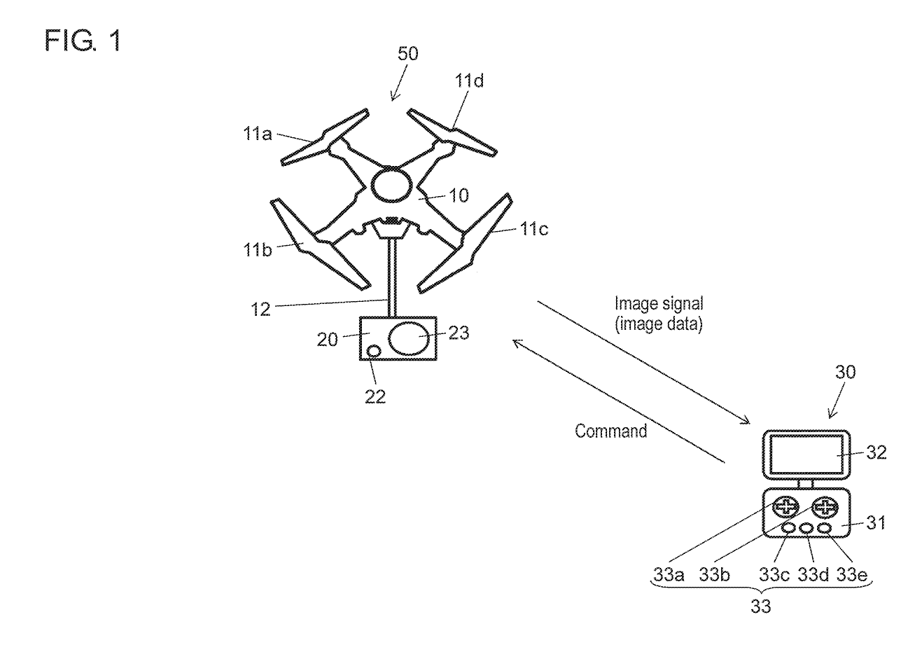

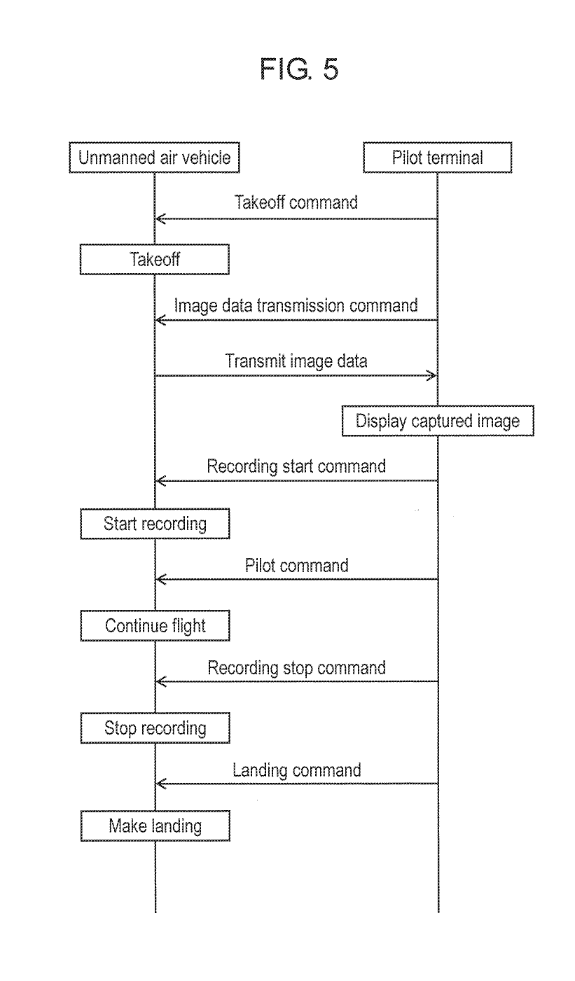

The first exemplary embodiment will be described with reference to FIG. 1 to FIG. 3, FIG. 5 to FIG. 12.

### 1. Configuration

[1-1. Overall Configuration of Unmanned Air Vehicle System]

FIG. 1 is a diagram illustrating an overall configuration of an unmanned air vehicle system according to the first exemplary embodiment. The unmanned air vehicle system includes unmanned air vehicle 50, pilot terminal 30, and display 32. Pilot terminal 30 can pilot unmanned air vehicle 50. In the first exemplary embodiment, display 32 is integral with pilot terminal 30.

Unmanned air vehicle 50 includes unmanned air vehicle body 10, four rotors 11a to 11d, attachment member 12, and camera unit 20.

Four rotors 11a to 11d are disposed on an identical plane and attached to unmanned air vehicle body 10. Motors for rotors 11a to 11d can be controlled independently. Rotations of rotors 11a to 11d are controlled by a control unit.

Attachment member 12 is connected to unmanned air vehicle body 10. Attachment member 12 may be integral with unmanned air vehicle body 10.

Camera unit 20 is attached to unmanned air vehicle body 10 by using attachment member 12.

Camera unit 20 includes main camera 23 and sub camera 22. Main camera 23 and sub camera 22 are integrally configured. The configurations of main camera 23 and sub camera 22 will be described later. An image signal (image data) obtained by camera unit 20 is not only used as collected data but also checked on the ground as needed and used as assistance in piloting unmanned air vehicle 50.

Pilot terminal 30 receives the image signal captured by camera unit 20 of unmanned air vehicle 50. Thus, the unmanned air vehicle system of the first exemplary embodiment includes an image transmission section for checking the image captured by unmanned air vehicle 50 on display 32 of pilot terminal 30. In addition to the image signal (image data) obtained from camera unit 20 of unmanned air vehicle 50, pilot terminal 30 receives, from unmanned air vehicle 50, flight data made by various sensors (including altimeter, global positioning system (GPS), accelerometer) installed in unmanned air vehicle 50. Pilot terminal 30 includes operation unit 33 and display 32.

Operation unit 33 is provided in a console of pilot terminal 30. Operation unit 33 includes hardkeys such as directional pads 33a, 33b and operation buttons 33c, 33d, 33e. The pilot of unmanned air vehicle 50 transmits various commands, which will be described later, to unmanned air vehicle 50 by using operation unit 33 to pilot unmanned air vehicle 50.

Display 32 displays an image captured by camera unit 20. While display 32 is integral with pilot terminal 30, display 32 may be independent of pilot terminal 30. When unmanned air vehicle 50 is positioned at a distance where unmanned air vehicle 50 can be visually perceived, the pilot can perform operations while looking at unmanned air vehicle 50 itself. However, when unmanned air vehicle 50 is too far to be visually perceived, or when unmanned air vehicle 50 is too far to allow checking of a direction of unmanned air vehicle 50 although visual perception is possible, that is, when unmanned air vehicle 50 is hundreds of meters or more distant, the image signal (image data) is useful for piloting the unmanned air vehicle. Therefore, in piloting, the pilot pilots unmanned air vehicle 50 while looking at the image shown on a screen of display 32.

A photographer of camera unit 20 (the pilot in the first exemplary embodiment) can adjust a direction of camera unit 20 by looking at the image shown on the screen of display 32. This enables image capturing better suitable for purposes. Recording the image displayed on display 32 and using the image as collected data enable collection of more appropriate data.

The first exemplary embodiment describes a case where controller 45 corresponding to a control unit mounted in camera unit 20 performs a process regarding operations of unmanned air vehicle body 10 and a process regarding operations of camera unit 20 together.

[1-2 Configuration of Camera Unit]

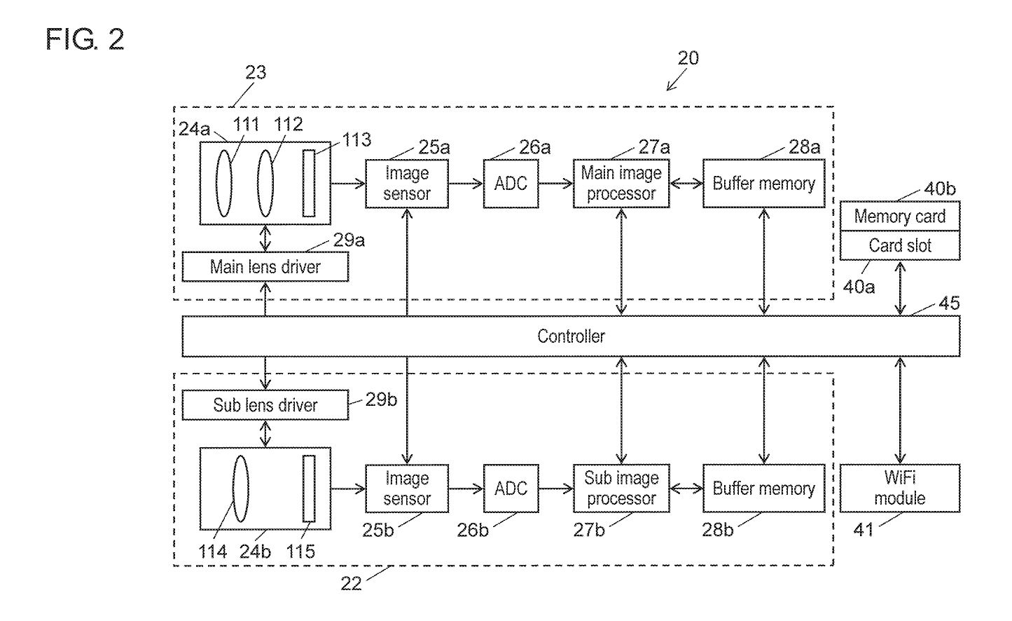

Next, an electric configuration of camera unit 20 will be described with reference to FIG. 2.

[1-2-1. Configuration of Main Camera]

First, an electric configuration of main camera 23 will be described with reference to FIG. 2. Main camera 23 picks up a subject image formed by main optical system 24a with complementary metal oxide semiconductor (CMOS) image sensor 25a (hereinafter referred to as image sensor 25a). Image sensor 25a generates picked up image data (RAW data) based on the picked up subject image. The picked up image data is converted into a digital signal by an analog-to-digital converter (hereinafter referred to as ADC 26a). Main image processor 27a applies various processes to the picked up image data that undergoes conversion into the digital signal to generate image data. Controller 45 records the image data generated by main image processor 27a in memory card 40b installed in card slot 40a.

Main optical system 24a includes one or a plurality of lenses. In the first exemplary embodiment, main optical system 24a includes zoom lens 111, focus lens 112, diaphragm 113, and the like. Movement of zoom lens 111 along an optical axis allows enlargement and reduction of the subject image. Movement of focus lens 112 along the optical axis allows focus adjustment of the subject image. In diaphragm 113, a size of an aperture is adjusted automatically or in response to user settings to adjust an amount of light to transmit. A telephoto lens is mounted in main camera 23. An angle of view of main camera 23 is narrower than an angle of view of sub camera 22 to be described later. Main camera 23 is an interchangeable lens camera.

Main lens driver 29a includes actuators that drive zoom lens 111, focus lens 112, and diaphragm 113. Main lens driver 29a controls the actuators, for example.

Image sensor 25a picks up the subject image formed via main optical system 24a to generate the picked up image data. Image sensor 25a performs various operations such as exposure, transfer, and electronic shutter. Image sensor 25a generates image data of new frames at a predetermined frame rate (for example, 30 frames per second). Controller 45 controls picked up image data generating timing and electronic shutter operations in image sensor 25a. An image pick up element is not limited to the CMOS image sensor, and other image sensors may be used, such as a charge coupled device (CCD) image sensor and an n-channel metal oxide semiconductor (NMOS) image sensor.

ADC 26a converts analog image data generated by image sensor 25a into digital image data.

Main image processor 27a applies various processes to the image data that undergoes digital conversion by ADC 26a, and then generates image data to be stored in memory card 40b. Non-limiting examples of the various processes include white balance correction, gamma correction, YC conversion process, electronic zoom process, compression process into a compression format that complies with the H.264 standard or the Moving Picture Experts Group (MPEG) 2 standard, and expansion process, Main image processor 27a may include hard-wired electronic circuitry, or a microcomputer using a program and the like.

Controller 45 controls overall operations of camera unit 20 in an integrated manner. Controller 45 may include hard-wired electronic circuitry, or a microcomputer and the like. Controller 45 may be formed of one semiconductor chip along with main image processor 27a and the like. Also, controller 45 incorporates a read-only memory (ROM). The ROM stores a service set identifier (SSID) and a wired equivalent privacy (WEP) key necessary for establishing wireless fidelity (WiFi) communication with other communication devices. Controller 45 can read the SSID and WEP key from the ROM as necessary. The ROM also stores a program for controlling the overall operation of camera unit 20 in an integrated manner, in addition to programs for autofocus control (AF control), rotation control of rotor 11a to rotor 11d, and communication control.

Buffer memory 28a is a storage medium that functions as a work memory for main image processor 27a and controller 45. Buffer memory 28a is implemented by a dynamic random access memory (DRAM) or the like.

[1-2-2. Configuration of Sub Camera]

Next, an electric configuration of sub camera 22 will be described with reference to FIG. 2. In sub camera 22, CMOS image sensor 25b (hereinafter referred to as image sensor 25b) picks up the subject image formed by sub optical system 24b. Image sensor 25b generates picked up image data (RAW data) based on the picked up subject image. The picked up image data is converted into a digital signal by an analog-to-digital converter (hereinafter referred to as ADC 26b). Sub image processor 27b applies various processes to the picked up image data that undergoes conversion into the digital signal to generate image data. Controller 45 records the image data generated by sub image processor 27b in memory card 40b installed in card slot 40a.

Sub optical system 24b includes one or a plurality of lenses. Sub optical system 24b includes focus lens 114, diaphragm 115, and the like. The configuration of each element is similar to the configuration of each element included in main camera 23 and thus detailed description thereof will be omitted. However, a wide-angle lens is mounted in sub camera 22. Here, types of elements that constitute sub optical system 24b of sub camera 22 are not limited to focus lens 114 and diaphragm 115, and a zoom lens or the like may be included.

Principal configurations of sub lens driver 29b, image sensor 25b, ADC 26b, and sub image processor 27b, and buffer memory 29b included in sub camera 22 are similar to principal configurations of main lens driver 29a, image sensor 25a, ADC 26a, main image processor 27a, and buffer memory 28a included in main camera 23, and thus detailed description of the principal configurations will be omitted. Here, when a fixed-focus optical system is used as sub optical system 24b of sub camera 22, sub lens driver 29b does not need to be present.

The foregoing has described the electric configurations of main camera 23 and sub camera 22 of camera unit 20. Next, other components included in camera unit 20 will be described.

Camera unit 20 further includes card slot 40a and WiFi module 41.

Memory card 40b is detachable to card slot 40a. Card slot 40a is a connecting section to connect between camera unit 20 and memory card 40b electrically and mechanically.

Memory card 40b is an external memory that incorporates a recording element such as a flash memory. Memory card 40b can store data such as the image data generated by main image processor 27a and sub image processor 27b.

WiFi module 41 is one example of the image transmission section. WiFi module 41 is a communication module that performs communication in conformity with the communications standard IEEE 802.11n. WiFi module 41 incorporates a WiFi antenna. Via WiFi module 41, camera unit 20 can communicate with pilot terminal 30, which is another communication device on which WiFi module 42 is mounted. WiFi module 41 receives operation instruction signals corresponding to various commands that are sent using operation unit 33 of the console of pilot terminal 30. In response to these operation instruction signals, controller 45 of camera unit 20 performs motor drive of rotor 11a to rotor 11d, operations to transmit or record image data captured by camera unit 20, and operations to record and stop the image data captured by camera unit 20. Camera unit 20 may perform direct communication with other communication devices via WiFi module 41, and may perform communication via an access point. Here, in place of WiFi module 41, the image transmission section may use a communication module that performs communication in conformity with another communications standard.

[1-3. Configuration of Pilot Terminal]

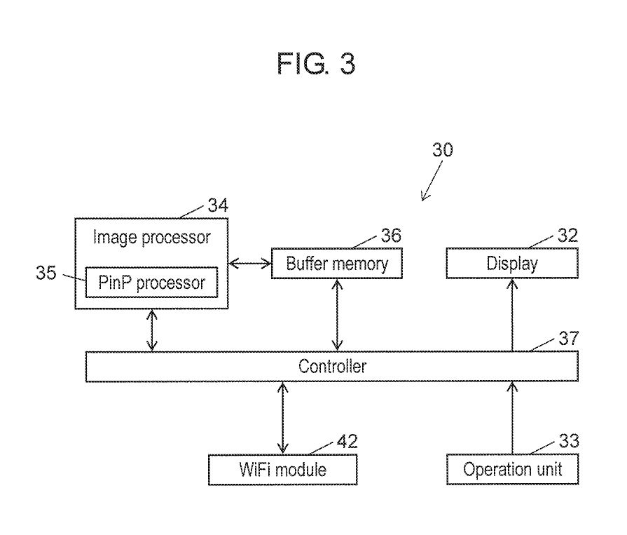

The electric configuration of pilot terminal 30 will be described with reference to FIG. 3. Pilot terminal 30 includes WiFi module 42, image processor 34, buffer memory 36, controller 37, display 32, and operation unit 33.

WiFi module 42 is one example of a signal transmission and reception section. WiFi module 42 is a communication module that performs communication in conformity with the communications standard IEEE 802.11n. WiFi module 42 incorporates a WiFi antenna. WiFi module 42 receives the image signal (image data) transmitted from WiFi module 41 of camera unit 20. When WiFi module 41 of camera unit 20 sends flight data made by various sensors installed, in unmanned air vehicle 50 (including altimeter, GPS, accelerometer), WiFi module 42 also receives this flight data.

Image processor 34 incorporates picture-in-picture (PinP) processor 35. PinP processor 35 performs a superimposition process (PinP process) of a sub image on a main image by using the image signal received by WiFi module 42. Controller 37 displays on display 32 the image data that undergoes the superimposition process performed by PinP processor 35.

Buffer memory 36 is a storage medium that functions as a work memory for image processor 34 and controller 37. Buffer memory 36 is, for example, a DRAM.

Controller 37 controls overall operations of pilot terminal 30 in an integrated manner. Controller 37 generates the operation instruction signal based on an operating command and transmits the operation instruction signal to unmanned air vehicle 50 by using WiFi module 42. Controller 37 may include hard-wired electronic circuitry, or a microcomputer and the like. Controller 37 may be formed of one semiconductor chip along with image processor 34 and the like. Also, controller 37 incorporates a ROM. The ROM stores an SSID and a WEP key necessary for establishing WiFi communication with other communication devices. Controller 37 can read the SSID and WEP key from the ROM as necessary. The ROM also stores a program for controlling the overall operation of pilot terminal 30 in an integrated manner, in addition to programs for communication control.

Display 32 is, for example, a liquid crystal monitor. Display 32 displays an image based on the image data processed by image processor 34. When unmanned air vehicle 50 sends the flight data made by various sensors installed in unmanned air vehicle 50 (including altimeter, GPS, accelerometer), display 32 may display this flight data along with the image. Note that display 32 is not limited to a liquid crystal monitor, but may use another monitor, such as an organic electroluminescence (EL) monitor.

Operation unit 33 is a general term for hardkeys included in the console of pilot terminal 30, such as directional pads 33a, 33b and operation buttons 33c, 33d, 33e, Operation unit 33 receives an operation made by an operator, such as a pilot. On receipt of the operation made by the operator, operation unit 33 notifies an operating command corresponding to the operation to controller 37. Note that in place of directional pads 33a, 33b, a lever such as a joystick can also be used, The pilot transmits various commands to unmanned air vehicle 50 by using operation unit 33 to pilot unmanned air vehicle 50.

The commands transmitted from operation unit 33 include a takeoff-landing command to cause unmanned air vehicle 50 to take off and make a landing, a pilot command such as a command to cause unmanned air vehicle 50 to perform posture control such as upward and downward movement and rightward and leftward movement, a captured image data transmission command to cause image data captured by camera unit 20 to be transmitted, and a recording start-stop command to cause the image data captured by camera unit 20 to be recorded or stopped. Command assignment of operation unit 33 is illustrated below. For example, a posture control command to control posture of unmanned air vehicle 50 is assigned to directional pad 33a. The captured image data transmission command is assigned to operation button 33c. The recording start-stop command is assigned to operation button 33d. The takeoff landing command is assigned to operation button 33e. Note that when a camera angle of main camera 23 and a camera angle of sub camera 22 can be changed synchronously, a camera angle command to change the camera angle may be assigned. to directional pad 33b.

### 2. Operation

One example of operations of the unmanned air vehicle system configured as described above will be described below.

FIG. 5 is an operating sequence diagram illustrating one example of operations of the unmanned air vehicle system according to the first exemplary embodiment. FIG. 5 illustrates an operation to operate unmanned air vehicle body 10 and camera unit 20 by using pilot terminal 30, and an operation of pilot terminal 30 to display the image captured by main camera 23 and the image captured by sub camera 22 on display 32 in a superimposed manner.

The pilot sends a takeoff command from pilot terminal 30 to unmanned air vehicle 50 by using operation button 33e. Specifically, controller 37 causes WiFi module 42 to transmit the operation instruction signal corresponding to the takeoff command. WiFi module 41 of unmanned air vehicle 50 receives this operation instruction signal. In response to this operation instruction signal, controller 45 of camera unit 20 drives the motors of rotor 11a to rotor 11d, causing unmanned air vehicle 50 to take off.

Next, the pilot sends an image data transmission command to unmanned air vehicle 50 by using operation button 33c, Specifically, controller 37 causes WiFi module 42 to transmit the operation instruction signal corresponding to the image data transmission command. WiFi module 41 of unmanned air vehicle 50 receives this operation instruction signal. In response to this operation instruction signal, controller 45 of camera unit 20 causes main camera 23 and sub camera 22 to start capturing images, and causes WiFi module 41 to transmit image data captured by main camera and sub camera 22. WiFi module 42 of pilot terminal 30 receives the image data transmitted from WiFi module 41 of unmanned air vehicle 50. Controller 37 causes PinP processor 35 to superimpose the received image data. That is, image data captured by main camera 23 (first image) and image data captured by sub camera 22 (second image) are transmitted from camera unit 20 and undergo a superimposition process in pilot terminal 30.

Subsequently, controller 37 causes display 32 of pilot terminal 30 to display the image that undergoes the superimposition process. A mode of superimposed display will be described later. The pilot can pilot unmanned air vehicle 50 while looking at the image displayed in a superimposed manner on display 32.

Next, the pilot sends a recording start command to unmanned air vehicle 50 by using operation button 33d. Specifically, controller 37 causes WiFi module 42 to transmit the operation instruction signal corresponding to the recording start command. WiFi module 41 of unmanned air vehicle 50 receives this operation instruction signal. In response to this operation instruction signal, controller 45 of camera unit 20 starts recording of the image captured by main camera 23 and sub camera 22 in memory card 40b.

Subsequently, the pilot can control flight of unmanned air vehicle 50 by sending various pilot commands to unmanned air vehicle 50 in accordance with a flight plan of unmanned air vehicle 50. After the flight plan is finished, the pilot sends, to unmanned air vehicle 50, a recording stop command to stop recording of the captured image and a landing command to cause unmanned air vehicle 50 to make a landing.

On receipt of the recording stop command, camera unit 20 stops recording of the captured image. On receipt of the landing command, unmanned air vehicle 50 makes a landing.

### 3. Display Examples

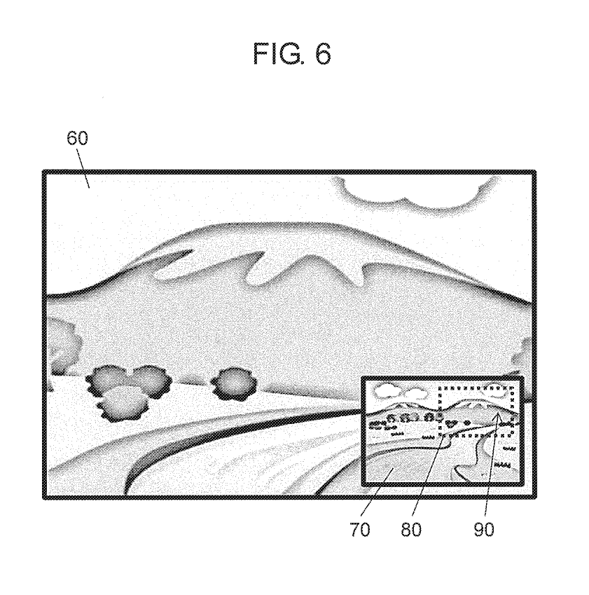

Display examples of the image captured by camera unit 20 in display 32 will be described with reference to FIG. 6 to FIG. 12.

FIG. 6 to FIG. 9 each illustrate a display example in which main camera 23 (first camera) captures an image of a mountain and a road in a foot of the mountain (first image 60), whereas sub camera 22 (second camera) captures an image of an overall scene including first image 60 (second image 70).

FIG. 6 illustrates an image in which second image 70 is superimposed inside first image 60. FIG. 6 also illustrates region frame 80 corresponding to a region of first image 60 superimposed inside second image 70. Inside of region frame 80 is referred to as main camera capturing region 90. A size of second image 70 displayed in a superimposed manner on first image 60 is determined by a positional relationship between main camera 23 and sub camera 22, and by a focal length of the lens of main optical system 24a. At least one of the size of second image 70 and a position at which to display the second image inside first image 60 may be changeable automatically or in response to operations of the operator such as the pilot, to the extent that checking of first image 60 is not affected.

In the display example of FIG. 6, region frame 80 corresponding to main camera capturing region 90 is displayed inside second image 70 so as to indicate correspondence between first image 60 and second image 70. While a frame line of region frame 80 is a dashed line, a type and color of the frame line is not particularly limited. Pilot terminal 30 changes a size of region frame 80 according to the focal length of an interchangeable lens installed in main camera 23. Region frame 80 is generated by image processor 34 and superimposed on second image 70. Controller 37 controls these superimposition processes. Controller 37 causes display 32 to display the image in which first image 60, second image 70, and region frame 80 are superimposed as illustrated in FIG. 6.

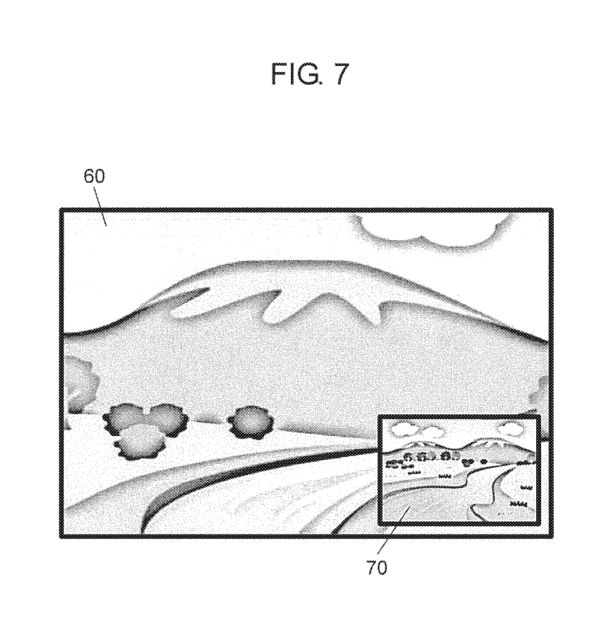

The display example in display 32 may be a display mode with region frame 80 eliminated from the display example of FIG. 6, as illustrated in FIG. 7.

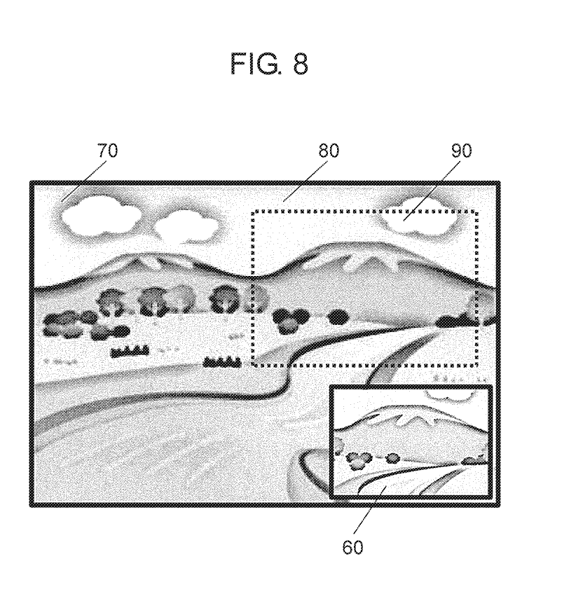

Also, as illustrated in FIG. 8, display 32 can display first image 60 inside second image 70. Second image 70 and region frame 80 corresponding to main camera capturing region 90 may be superimposed.

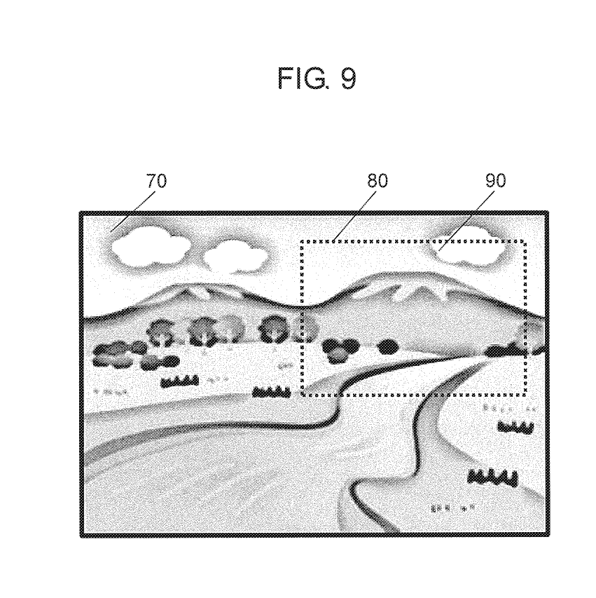

Furthermore, as illustrated in FIG. 9, first image 60 may be eliminated from the display mode illustrated in FIG. 8. That is, as illustrated in FIG. 9, display 32 may display an image in which second image 70 and region frame 80 corresponding to main camera capturing region 90 are superimposed.

Any one of the display modes of FIG. 6 to FIG. 9 may be able to be switched to another display mode illustrated in FIG. 6 to FIG. 9, or to first image 60 or second image 70 that does not undergo the superimposition process. For example, when region frame 80 in FIG. 9 is selected by using operation unit 33, display on display 32 may be switched to first image 60 or may be switched to one of the display modes of FIG. 6 to FIG. 8.

During piloting, when unmanned air vehicle 50 is too far to be visually perceived, or when unmanned air vehicle 50 is too far to allow checking of a direction of unmanned air vehicle 50 although visual perception is possible, the pilot can pilot unmanned air vehicle 50 with pilot terminal 30 while looking at one of the superimposed images of FIG. 6 to FIG. 8. Also, in the unmanned air vehicle system according to the present disclosure, even if an angle of view of main camera 23 is narrow, using the image captured by sub camera 22 as assistance facilitates piloting of unmanned air vehicle body 10.

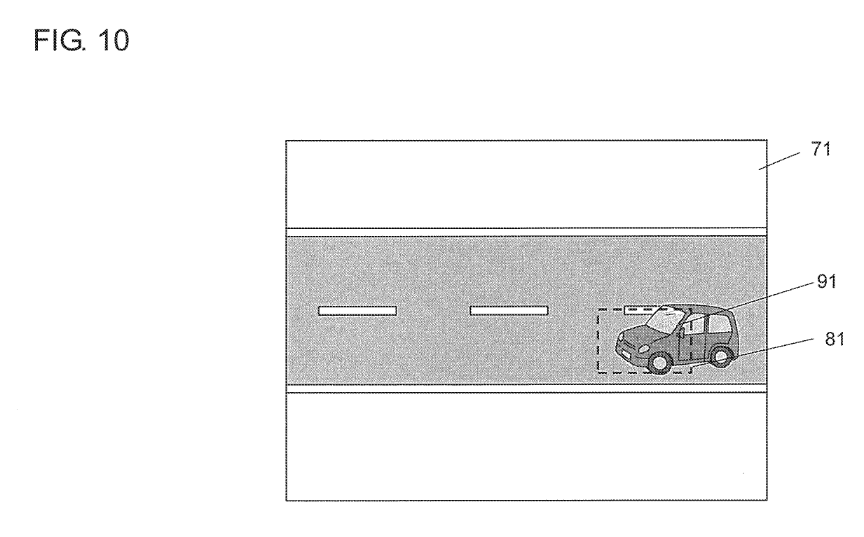

Furthermore, FIG. 10 to FIG. 12 illustrate the display examples in which main camera 23 (first camera) captures an image (first image 61) that allows checking of information on a car, such as a license plate and driver, whereas sub camera 22 (second camera) captures an image (second image 71) of an overall road including first image 61.

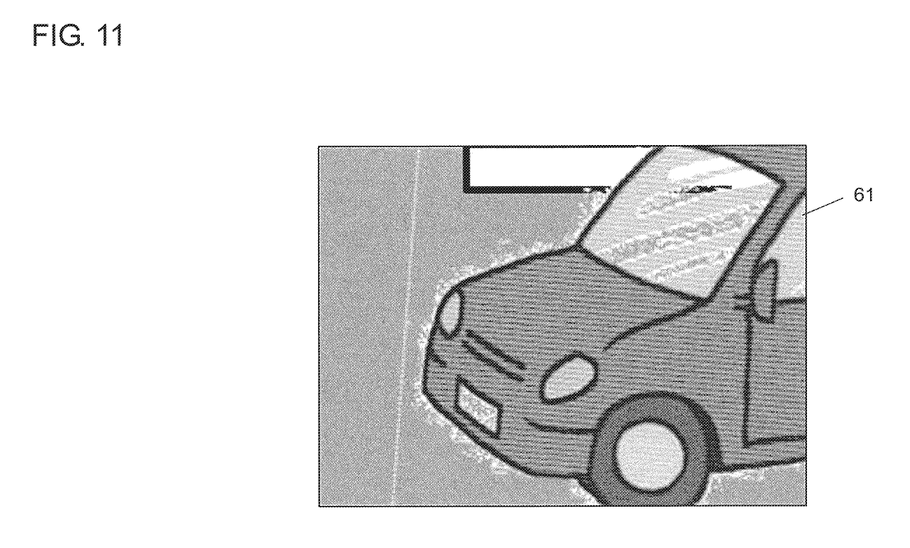

In FIG. 10, display 32 displays an image in which region frame 81 corresponding to a region of first image 61 is superimposed inside second image 71. In FIG. 11, display 32 displays only first image 61. In the display mode illustrated in FIG. 10, the operator such as the pilot may switch display to the display mode of FIG. 11 by selecting region frame 81 with operation unit 33. For example, while chasing a car illustrated in FIG. 10 from a viewpoint of crime prevention and security, the operator can know a position and direction of the car on a road while checking a screen of FIG. 10. Then, the operator can check the license plate of the car and driver's face by switching to the screen of FIG. 11. Then, the operator may return to the screen of FIG. 10 again.

In FIG. 12, display 32 displays an image in which second image 71 is superimposed inside first image 61. In FIG. 12, display 32 further displays region frame 81 corresponding to the region of first image 61 (main camera capturing region 91) inside second image 71.

While the superimposed image illustrated in FIG. 12 may be generated by image processor 34 of pilot terminal 30 like the superimposed image illustrated in FIG. 6, the superimposed image may be generated by unmanned air vehicle body 10 or camera unit 20, for example. That is, unmanned air vehicle body 10 or camera unit 20 may include image processor 34. In this case, data of first image 61 and data of second image 71 are combined by unmanned air vehicle 50. Then, the combined image data is transmitted to pilot terminal 30 via WiFi module 41, and is displayed on display 32.

When unmanned air vehicle 50 superimposes first image 61 and second image 71, the data to be transmitted to pilot terminal 30 can be unified. Also, volume of the data to be transmitted can be reduced compared with a case of sending the data of first image 61 and the data of second image 71 separately.

Here, the display mode of display 32 may be able to be switched from the display mode illustrated in FIG. 12, for example, to the display mode illustrated in FIG. 11. An operation for switching the display mode of display 32 will be described with reference to the operating sequence diagram of FIG. 5.

For example, pilot terminal 30 transmits, to unmanned air vehicle 50, a command to transmit superimposed image data illustrated in FIG. 12 (data transmission command). Unmanned air vehicle 50 transmits the combined superimposed image data to pilot terminal 30. Based on the transmitted superimposed image data, display 32 displays the image illustrated in FIG. 12.

Next, pilot terminal 30 transmits an image switching command to unmanned air vehicle 50. This switching command is a command to instruct unmanned air vehicle 50 to switch display, for example, from the superimposed image illustrated in FIG. 12 to first image 61 illustrated in FIG. 11. Unmanned air vehicle 50 transmits the image data switched in response to the switching command, that is, the data of first image 61. On receipt of the data of first image 61, pilot terminal 30 displays, on display 32, first image 61 illustrated in FIG. 11.

When switching again from first image 61 to the superimposed image illustrated in FIG. 12, pilot terminal 30 further transmits the switching command to unmanned air vehicle 50. Unmanned air vehicle 50 combines the images again and transmits the superimposed image data to pilot terminal 30.

### 4. SUMMARY

Unmanned air vehicle 50 of the unmanned air vehicle system includes main camera 23 and sub camera 22. This allows the unmanned air vehicle system to use the image captured by sub camera 22 as assistance even if the angle of view of main camera 23 is narrow. This facilitates piloting of unmanned air vehicle body 10. This also facilitates the operation of the camera unit to capture images.

Also, display 32 can display first image (60, 61) captured by main camera 23 and second image (70, 71) captured by sub camera 22 in a superimposed manner. That is, the pilot can pilot unmanned air vehicle 50 while looking at the superimposed image illustrated in FIG. 6 to FIG. 8, FIG. 12, further facilitating piloting of unmanned air vehicle body 10. Also, this further facilitates the operation to capture images with camera unit 20.

When first image (60, 61) and second image (70, 71) are displayed in a superimposed manner, second image (70, 71) smaller than first image (60, 61) may be displayed in a superimposed manner inside first image (60, 61), whereas first image (60, 61) smaller than second image (70, 71) may be displayed in a superimposed manner inside second image (70, 71). Setting the superimposition mode according to purposes further facilitates piloting unmanned air vehicle body 10. Also, this further facilitates the operation to capture images with camera unit 20.

Also, display 32 can display the image in which region frame (80, 81) corresponding to the region of first image (60, 61) of main camera 23 is superimposed inside second image (70, 71) of sub camera 22. That is, the pilot can pilot unmanned air vehicle 50 while checking the superimposed image illustrated in FIG. 9 or FIG. 10. That is, the pilot can mainly check second image (70, 71) as necessary.

Also, display 32 can display region frame (80, 81) corresponding to the region of first image (60, 61) inside second image (70, 71). Accordingly, the pilot can know what first image (60, 61) is displaying while checking secondimage (70, 71).

Also, display 32 can change at least one of the size of second image (70, 71) and position at which to display second image (70, 71) inside first image (60, 61) for display. This allows display of images better suitable for purposes.

Also, display 32 can change the size of region frame (80, 81) according to the focal length of the lens installed in main camera 23 for display. Accordingly, even when the lens of main camera 23 is an interchangeable lens, display 32 can perform appropriate display.

Also, display 32 can switch display between the image in which second image (70, 71) and region frame (80, 81) corresponding to the region of first image (60, 61) inside second image (70, 71) are superimposed, and the image including first image (60, 61). The switched image may be only first image (60, 61), and may be the image in which second image (70, 71) is superimposed inside first image (60, 61). This allows display of images better suitable for purposes.

The unmanned air vehicle system also includes image processor 34 that generates region frame (80, 81) and further performs the superimposition process of first image (60, 61), second image (70, 71), and region frame (80, 81). The unmanned air vehicle system also includes controller 37 that causes display 32 to display the superimposed image.

### Other Exemplary Embodiments

The present disclosure is not limited to the above-described first exemplary embodiment, and various exemplary embodiments can be considered.

Other exemplary embodiments of the present disclosure will be described together below.

Camera unit 20 of the first exemplary embodiment can be attached to unmanned air vehicle body 10 by using attachment member 12. However, camera unit 20 may be directly mounted in unmanned air vehicle body 10, and may be connected via a vibration control device such as gimbal. Also, unmanned air vehicle body 10 may be integral with camera unit 20.

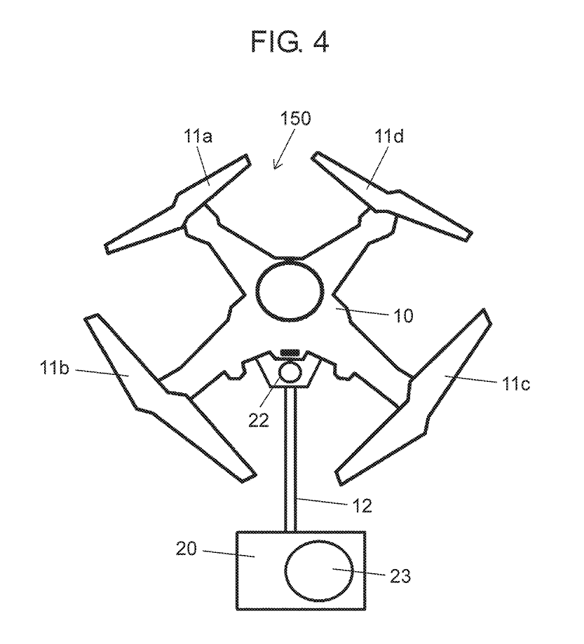

Camera unit 20 of the first exemplary embodiment is configured with integrated main camera 23 and sub camera 22. However, sub camera 22 may be mounted together in camera unit 20 in which main camera 23 is mounted, and only sub camera 22 may be mounted close to unmanned air vehicle body 10 (or as an integral type). For example, main camera 23 may be mounted via the vibration control device, whereas sub camera 22 may be mounted at a position closer to unmanned air vehicle body 10 than to a connection section between unmanned air vehicle body 10 and the vibration control device. Alternatively, as illustrated in FIG. 4, sub camera 22 may be fixed to unmanned air vehicle body 10, whereas camera unit 20 including main camera 23 may be attached to unmanned air vehicle body 10 by using attachment member 12. However, main camera 23 and sub camera 22 are preferably mounted so as to prevent change in relative positions of main camera 23 and sub camera 22.

The lens of main camera 23 of the first exemplary embodiment is an interchangeable lens that allows interchange with another lens; however, the lens of main camera 23 may be a fixed lens.

The first exemplary embodiment has described that controller 45 mounted in camera unit 20 performs the process of unmanned air vehicle body 10 and the process of camera unit 20 together; however, these processes may be performed separately.

The first exemplary embodiment has described that pilot terminal 30 is configured as one device including display 32; however, a terminal such as a smartphone or tablet terminal may be attached to the pilot terminal body to constitute pilot terminal 30. That is, an operation unit, display, and communication unit of the terminal may be used as operation unit 33, display 32, and WiFi module 42 of pilot terminal 30, respectively.

Display 32 of the first exemplary embodiment is integral with pilot terminal 30; however, display 32 may be independent of pilot terminal 30.

In the first exemplary embodiment, the unmanned air vehicle system includes one display 32; however, the unmanned air vehicle system may include a plurality of the displays 32. For example, when the pilot who pilots unmanned air vehicle 50 and the photographer who captures images with camera unit 20 are different persons, that is, when a plurality of operators operates the unmanned air vehicle system, each operator can look at display 32 for each operator. Also, each display 32 may display a different image. For example, each display 32 may display the image captured by main camera 23 and the image captured by sub camera 22 in a different superimposition, mode, and may display region frames 80, 81 in a different mode.

Names of main camera 23 and sub camera 22 of the first exemplary embodiment are one example, and do not limit which one is to be mainly used.

Crime prevention and security applications have been cited as the application of the first exemplary embodiment; however, the application is not limited to this example. For example, the first exemplary embodiment is also applicable to aerial photographing of an athletic meeting. When a principal subject moves freely, display 32 is useful because display 32 can display various images as assistance in operations to pilot unmanned air vehicle 50 or to capture images with camera unit 20.

As described above, the exemplary embodiments have been described as illustration of the technology in the present disclosure. For this purpose, the accompanying drawings and detailed description have been provided.

Accordingly, the components described, in the accompanying drawings and detailed description may include not only components essential for solving problems but also components unessential for solving problems, in order to illustrate the technology. Therefore, it should not be acknowledged immediately that those unessential components be essential because those unessential components are described in the accompanying drawings and detailed description.

Also, since the aforementioned exemplary embodiments are intended to illustrate the technology in the present disclosure, various changes, replacements, additioris, omissions, etc. may be made within the scope of the appended claims or equivalents thereof.

The present disclosure is applicable to the unmanned air vehicle that is equipped with the cameras and that can be piloted using the pilot terminal. Specifically, the present disclosure is applicable to rotary wing unmanned aircrafts such as a helicopter and quadcopter.

What is claimed is:

1. An unmanned air vehicle system comprising:
an unmanned air vehicle including a camera unit;
a pilot terminal capable of piloting the unmanned air vehicle; and
a display that displays an image captured by the camera unit,
wherein the camera unit includes a first camera that captures a first image and a second camera that captures a second image, and
an angle of view of the first camera is narrower than an angle of view of the second camera.

2. The unmanned air vehicle system according to claim 1, wherein the display displays an image in which the first image and the second image are superimposed.

3. The unmanned air vehicle system according to claim 1, wherein the display displays an image in which the second image and a region frame corresponding to a region of the first image inside the second image are superimposed.

4. The unmanned air vehicle system according to claim 2, wherein the display further displays a region frame corresponding to a region of the first image superimposed inside the second image.

5. The unmanned air vehicle system according to claim 2, wherein the display displays the image in which the second image is superimposed inside the first image.

6. The unmanned air vehicle system according to claim 5, wherein the display changes at least one of a size of the second image and a position at which the second image is displayed inside the first image to perform display.

7. The unmanned air vehicle system according to claim 4, further comprising:
an image processor that performs a superimposition process for superimposing the first image and the second image, and generates the region frame; and
a controller that causes the display to display a superimposed image obtained by the superimposition process, the controller superimposing the region frame inside the second image of the superimposed image.

8. The unmanned air vehicle system according to claim 3, wherein
a lens of the first camera is interchangeable with another lens, and
the display changes a size of the region frame according to a focal length of the lens attached to the first camera to perform display.

9. The unmanned air vehicle system according to claim 3, wherein the display switches between the image in which the second image and the region frame corresponding to the region of the first image inside the second image are superimposed, and an image including the first image.
